(19) United States
(12) Patent Application Publication
(10) Pub. No.: US 2005/0029685 A1
(43) Pub. Date: Feb. 10, 2005

(54) Beverage mixer/aerator

(76) Inventor: Hang Zhao, Shen Zhen (CN)

Correspondence Address: ALIX YALE & RISTAS LLP, 750 MAIN STREET, SUITE 1400, HARTFORD, CT, 06103, US

(21) Appl. No.: 10/635,281

(22) Filed: Aug. 6, 2003

(51) Int. Cl. A47J 43/044

(52) U.S. Cl. 261/87; 366/129

(57) ABSTRACT

A beverage mixer/aerator for attachment to a hand-held housed motor includes an agitator for immersion in a beverage and a rotational driveshaft to which the agitator is affixed. The driveshaft has an air inlet port, an air outlet port at or adjacent to the agitator and a longitudinal passageway extending from the air inlet port to the air outlet port. The agitator draws air down through the passageway to improve infusion of air into a beverage in use.

### BACKGROUND OF THE INVENTION

The present invention relates to beverage mixers. More particularly, although not exclusively, the invention relates to a beverage mixer as might be used to froth milk and including aerator to induce vortices in liquid in which the aerator is immersed.

It is known to froth milk for example using a hand-held motor-driven rotary agitator. These comprise a handle within which there is an electric motor having an rotary output. Such devices are known to comprise a solid driveshaft at the end of which an agitator is affixed to rotate with the driveshaft. These devices do not infuse air into the liquid other than that which is drawn down from the liquid surface by cavitation effects that might otherwise be induced by the agitator.

### OBJECTS OF THE INVENTION

It is an object of the present invention to overcome or substantially ameliorate the above disadvantage and/or more generally to provide a beverage mixer/aerator having increased air-infusion efficiency.

### DISCLOSURE OF THE INVENTION

There is disclosed herein a beverage mixer/aerator comprising:
an agitator for immersion in a beverage,
a rotational driveshaft to which the agitator is affixed, the driveshaft having an air inlet port, an air outlet port at or adjacent to the agitator and a longitudinal passage extending from the air inlet port to the air outlet port.

Preferably the driveshaft is mounted to rotate within a housing.

Preferably the agitator is located within a cowling.

Preferably the cowling extends from the housing.

Preferably the driveshaft has a drive coupling at its end remote from the agitator.

Preferably the driveshaft comprises a length of hollow tube.

Preferably the air inlet port passes through a wall of the length of hollow tube.

Preferably the housing comprises an air inlet aperture through which air can pass en route to the air inlet port.

The preferably the driveshaft is mounted within the housing by a sealed bearing nearby the agitator.

Preferably the agitator comprises a disc that extends radially from the driveshaft.

The preferably there is a coil attached to and extending circumferentially about the disc.

Preferably the disc comprises an array of apertures adjacent its periphery and through which windings of the coil pass.

Preferably the housing is in the form of an attachment for temporarily connection to a motor housing within which an electric motor is situated for coupling to the driveshaft.

### BRIEF DESCRIPTION OF THE DRAWINGS

A preferred form of the present invention will now be described by way of example with reference to the accompanying drawings, wherein:

FIG. 1 is a schematic cross-sectional elevation of a mixing/aeration device for attachment to a hand-held motor housing,

FIG. 2 is a schematic cross-sectional elevation of a driveshaft and agitator,

FIG. 3 is a schematic cross-sectional close-up diagram showing detail of air inlet ports in the driveshaft,

FIG. 4 is a schematic plan of the agitator, and

FIG. 5 is a schematic cross-sectional elevation of the agitator.

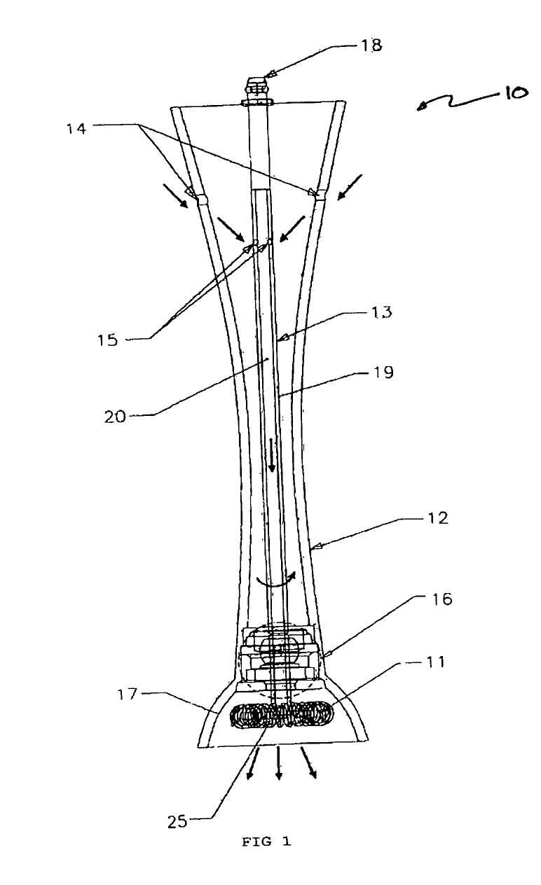

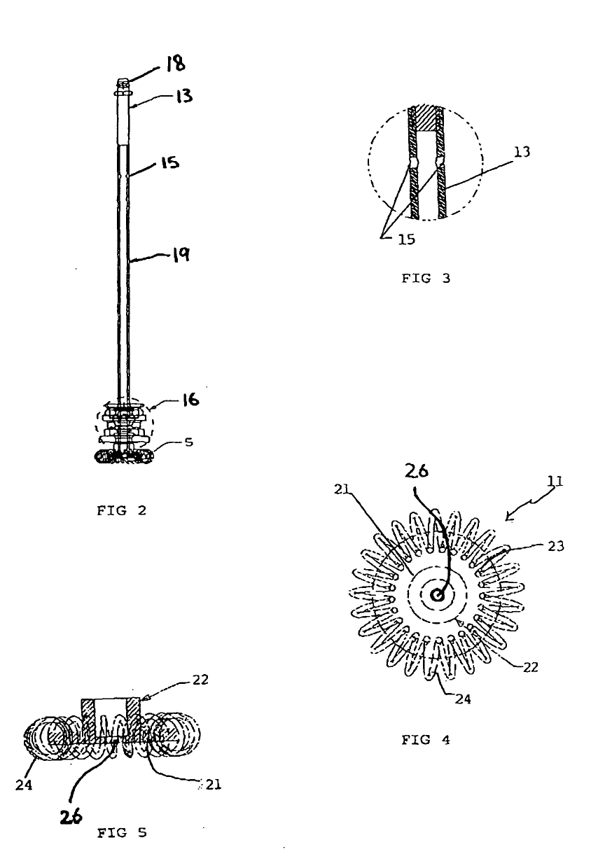

### DESCRIPTION OF THE PREFERRED EMBODIMENT

In the accompanying drawings there is depicted schematically a mixer/aerator attachment 10 for attachment to a hand-held housed motor that presents an output coupling to the attachment. The attachment comprises a moulded plastics housing 12 having a cowling 17 at its lower extremity. Within the housing 12, there extends a driveshaft 13, at the bottom end of which there is an agitator 11 located within the cowling 17. At the top end of the driveshaft 13 there is a drive coupling 18 to engage with the output coupling of the hand-held motor housing (not shown).

The driveshaft 13 is typically made of stainless-steel and comprises a hollow tubular length 19 within which there is a vertical passageway 20. A lower portion of this tubular length 19 passes through a sealed bearing 16 which locates the driveshaft 13 centrally within the housing 12.

The agitator 11 comprises a disc 21. In the preferred embodiment the disc 21 is made of ABS plastic. In alternative embodiments the disc 21 may be made of nylon or the like, and in other embodiments it may be made of stainless-steel. The disc 21 comprises an attachment flange 22 by which it is attached to the bottom end of the driveshaft's hollow portion 19 so as to rotate in unison therewith. The disc 21 has a central aperture 26 through which the driveshaft 19 passes, and a number of near-peripheral apertures 23 through which windings of a coil spring 24 pass. The coil spring 24 extends about the periphery of the disc 21 to provide a froth-inducing rotation element for immersion in a beverage such as milk infusion of air therein.

The driveshaft 13 comprises a pair of air inlet ports 15 high in the housing 12 beneath the drive coupling 18. The bottom end of the driveshaft 19 is open to provide an air outlet port 25.

Near the top of the housing 12, there are one or more air inlet apertures 14 through which air passes from the atmosphere en route to the air inlet ports 15.

In use when attached to a handheld motor housing, the agitator 11 and cowling 17 are immersed in a liquid to be frothed. The air inlet apertures 14 are to remain above the liquid surface of the beverage so as to draw in atmospheric air. Low-pressure is induced within the passageway 20 as a result of rotary high-speed motion of the agitator 11. Such high-speed rotation might otherwise induced cavitation in the beverage. Instead, the low-pressure draws air down through the passageway from the air inlet ports 15 and air inlet apertures 14 and is presented to the beverage via the air outlet port 25 for infusion therewith by the coil spring 24.

It should be appreciated that modifications and alterations obvious to those skilled in the art are not to be considered as beyond the scope of the present invention. For example, the housing 12 might be formed integrally with a motor housing —instead of being provided as a removable attachment. Furthermore, instead of providing a coil spring-on-disc agitator, rotary blades or other impellers might be attached to the bottom end of the driveshaft hollow portion 19. Furthermore, instead of providing an air outlet port 25 in the form of a simple open bottom end of the hollow driveshaft portion 19, air outlet ports might extend through the wall of the hollow portion 19 just above the agitator for example. This might improve down-flow of air-infused liquid beneath the agitator.

1. A beverage mixer/aerator comprising:
an agitator for immersion in a beverage,
a rotational driveshaft to which the agitator is affixed, the driveshaft having an air inlet port, an air outlet port at or adjacent to the agitator and a longitudinal passage extending from the air inlet port to the air outlet port.

2. The beverage mixer/aerator of claim 1 further comprising a housing within which the driveshaft is mounted to rotate.

3. The beverage mixer/aerator of claim 1 wherein the agitator is located within a cowling.

4. The beverage mixer/aerator of claim 1 wherein the driveshaft is mounted to rotate within a housing from which a cowling extends about the agitator.

5. The beverage mixer/aerator of claim 1 wherein the driveshaft has a drive coupling at its end remote from the agitator.

6. The beverage mixer/aerator of claim 1 wherein the driveshaft comprises a length of hollow tube.

7. The beverage mixer/aerator of claim 6 wherein the air inlet port passes through a wall of the length of hollow tube.

8. The beverage mixer/aerator of claim 2 wherein the housing comprises an air inlet aperture through which air can pass en route to the air inlet port.

9. The beverage mixer/aerator of claim 2 wherein the driveshaft is mounted within the housing by a sealed bearing nearby the agitator.

10. The beverage mixer/aerator of claim 1 wherein the agitator comprises a disc that extends radially from the driveshaft.

11. The beverage mixer/aerator of claim 10 further comprising a coil attached to and extending circumferentially about the disc.

12. The beverage mixer/aerator of claim 11 wherein the disc comprises an array of apertures adjacent its periphery and through which windings of the coil pass.

13. The beverage mixer/aerator of claim 2 wherein the housing is in the form of an attachment for temporarily connection to a motor housing within which an electric motor is situated for coupling to the driveshaft.
